(19) United States
(12) Patent Application Publication
(10) Pub. No.: US 2026/0244776 A1
(43) Pub. Date: Aug. 20, 2026

(54) SYSTEMS AND METHODS FOR A PERFORMANCE ENGINEERING BROWSER EXTENSION

(71) Applicant: ServiceNow, Inc., Santa Clara, CA (US)

(72) Inventor: Deepesh Kumar Joshi, Mathura (IN)

(21) Appl. No.: 19/058,686

(22) Filed: Feb. 20, 2025

(51) Int. Cl. G06F 21/62

(52) U.S. Cl. CPC G06F 21/6218

(57) ABSTRACT

A method includes receiving, via a browser extension, a request to assess performance of a web page, identifying an attribute of the web page, presenting, via the browser extension, based on the attribute, one or more affordances, wherein each affordance of the one or more affordances is associated with a performance characteristic of the web page, receiving a request to access data based on a selection of an affordance of the one or more affordances, and providing, via the browser extension, a representation of the data for display.

### TECHNICAL FIELD

The present disclosure relates generally to a browser extension for performance engineering processes.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Web page performance may be monitored and tracked to assess one or more functionalities of the web page. For example, a web page may execute one or more queries to retrieve and display information, such as to provide dashboard or widget functionality. Accordingly, the time it takes for the web page to execute the query and display the information may be tracked and monitored to assess the performance of the web page. Moreover, the performance of one or more functionalities of a web page may be parameterized as performance metrics. Accordingly, enterprises that maintain web pages may seek to identify, quantify, and report such performance metrics to monitor and improve the respective performance. However, it may be difficult to track multiple performance metrics simultaneously and in a manner that is compatible with complex workflows used to debug and monitor such performances. For example, assessing performance of a web page may involve manually running a large number of reports and parsing through the reports to draw conclusions. Accordingly, new techniques for increasing accessibility to performance metrics and associated workflows of a web page are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving, via a browser extension, a request to assess performance of a web page, identifying an attribute of the web page, presenting, via the browser extension and based on the attribute, one or more affordances, wherein each affordance of the one or more affordances is associated with a performance characteristic of the web page, receiving a request to access data based on a selection of an affordance of the one or more affordances, and providing, via the browser extension, a representation of the data for display.

In another embodiment, a system includes processing circuitry and a memory, accessible by the processing circuitry, storing instructions that, when executed by the processing circuitry, cause the processing circuitry to execute operations including accessing a web page via a browser having a browser extension configured thereon. The browser extension is configured to receive a request to assess the performance of the web page, identify an attribute of the web page, present, based on the attribute, one or more affordances, wherein each affordance of the one or more affordance is associated with a performance characteristic of the web page, receive a request to access data based on a selection of an affordance of the one or more affordances, and provide a representation of the data for display.

In a further embodiment, a non-transitory, computer readable medium stores instructions that, when executed by processing circuitry, cause the processing circuitry to receive a request to assess performance of a web page, identify an attribute of the web page, present, based on the attribute, one or more affordances, wherein each affordance of the one or more affordance is associated with a performance characteristic of the web page, receive a request to access data based on a selection of an affordance of the one or more affordances, and provide a representation of the data for display.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server, which supports and enables a client instance, and hosts performance engineering tool(s) for a browser extension, in accordance with aspects of the present disclosure;

FIG. 5 is a flowchart of a process for determining a certain performance engineering workflow to display via the browser extension, in accordance with aspects of the present disclosure;

FIG. 6 is a flowchart of a process for providing access to one or more performance engineering tools based on an attribute of a web page, in accordance with aspects of the present disclosure;

FIG. 7 is a screen shot of an embodiment of a browser extension display of the one or more performance engineering tools, in accordance with the flowchart of FIG. 6, in accordance with aspects of the present disclosure;

FIG. 8 is a flowchart of a process for providing the one or more performance engineering tools of FIG. 7, wherein the browser extension is configured to provide access to a stack trace associated with a particular slow query, in accordance with aspects of the present disclosure;

FIG. 9 is a screen shot of an embodiment of the stack trace functionality of the browser extension, in accordance with the flowchart of FIG. 8;

FIG. 10 is a flowchart of a process for generating and providing a report for a web page testing environment via the browser extension; and

FIG. 11 is a screen shot of an embodiment of the report generation functionality for web page testing environments, in accordance with the flowchart of FIG. 10.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic”, “automated”, “autonomous”, and so forth, are intended to describe operations that are performed are caused to be performed, for example, by a computing system (i.e., solely by the computing system, without human intervention). Indeed, although certain operations described herein may not be explicitly described as being performed automatically in substantially real time during operation of the computing system and/or equipment controlled by the computing system, it will be appreciated that these operations may, in fact, be performed automatically in substantially real time during operation of the computing system and/or equipment controlled by the computing system to improve the functionality of the computing system (e.g., by not requiring human intervention, thereby facilitating faster operational decision-making, as well as improving the accuracy of the operational decision-making by, for example, eliminating the potential for human error), as described in greater detail herein.

As previously discussed, an enterprise may seek to identify, quantify, and report performance metrics to improve a respective performance aspect of a web page. However, it may be difficult to track multiple performance metrics simultaneously, and in a manner that is compatible with complex workflows used to debug and monitor such performances. For example, assessing performance of a web page may involve manually running a large number of reports and parsing through the reports to draw conclusions. Accordingly, new techniques for increasing accessibility to performance metrics and associated workflows of a web page are needed.

Implementations of the presently described technique are directed to systems and methods to monitor and access performance metrics and workflows of a web page via a browser extension. In embodiments described herein, the browser extension may be used to identify and access workflows to optimize an associated performance of the web page based on an attribute of the web page (e.g., URL, source code, etc.). For example, the browser extension may identify that the web page is related to debugging one or more functions of the web page (e.g., slow queries, slow transactions, slow scripts, etc.) and provide access to the one or more relevant workflows via any suitable user interactivity options (e.g., hyperlinks, buttons, etc.). As a further example, the browser extension may identify and display stack traces (e.g., the logical call order of methods/functions of an execution) of certain web page executions thereby providing access to one or more stack frames of the executions for debugging. In certain embodiments, the browser extension may populate a report based on the type of web page from which the browser extension is requested. For example, a web page may be identified as a web page testing environment for designing optimization processes by way of test cases. Accordingly, the browser extension may populate a report based on the key performance indicators (KPIs) of such test cases in the testing environment and provide one or more options to export the report to an external source (e.g., XSLX files, CSV files, XML files, etc.).

Use of the disclosed techniques may enable an enterprise to streamline performance engineering processes by providing easy access to various tools and metrics associated with improving web page performance. As such, performance engineering processes may operate with greater efficiency, utilizing few computer, human, and other resources, resulting in faster, better performing web pages.

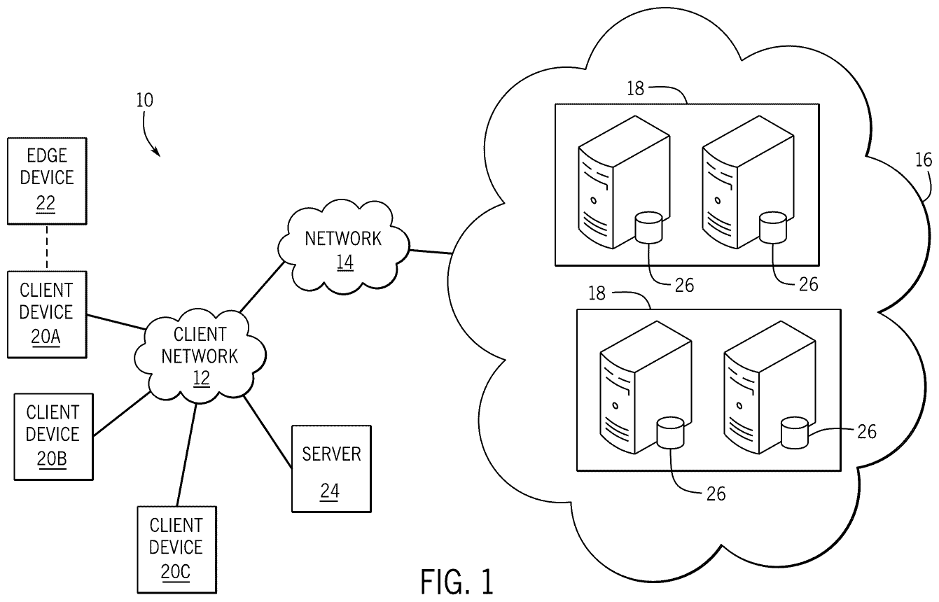

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to, a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

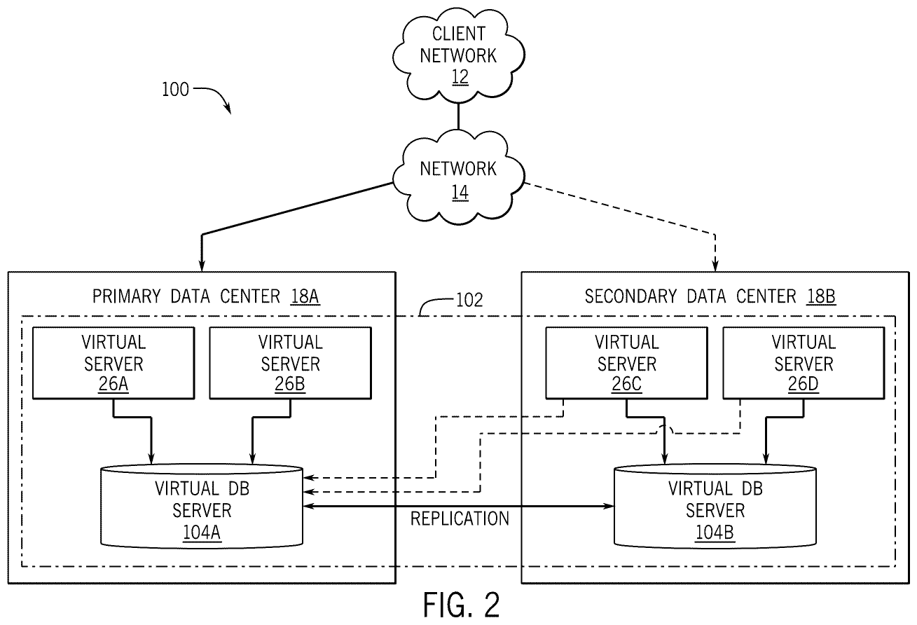

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

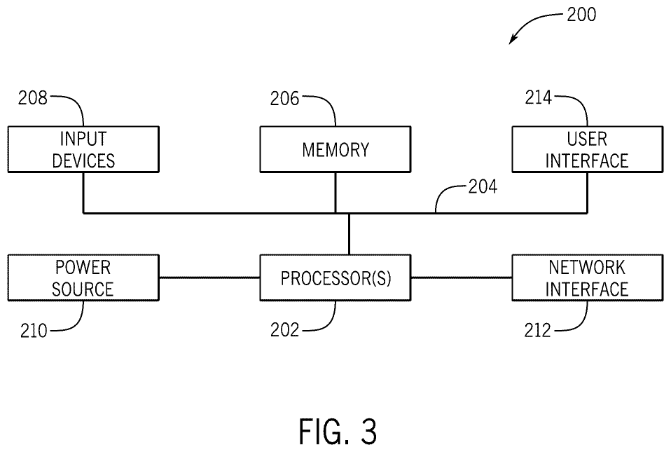

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

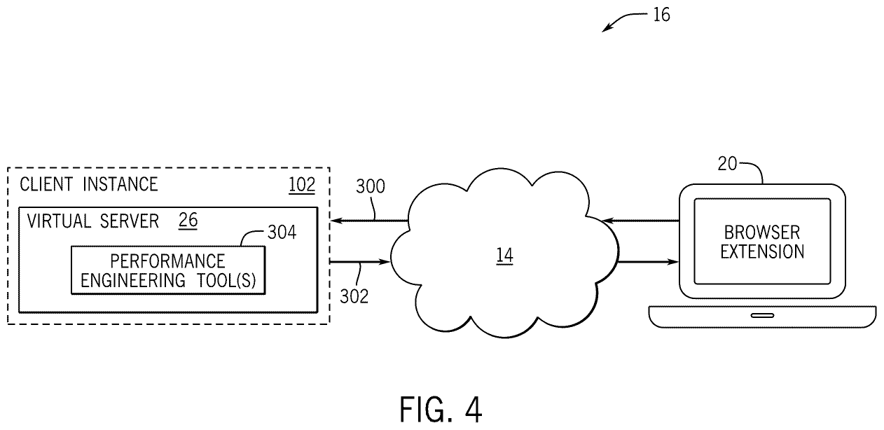

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via an application or web browser running on the client device 20). Client instance 102 is supported by virtual servers 26 similar to those explained with respect to FIG. 2 and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using a web browser and/or an application. As such, the web browser and/or application may be configured to support a browser extension. As such, the client device 20 may transmit inputs 300 (e.g., requests) and the client instance 102 generate and transmit outputs 302 (e.g., responses), as facilitated by the browser extension. In interacting with the client device 20, the client instance 102 may interface with one or more performance engineering tools 304 hosted on the virtual server 26.

In certain embodiments, the performance engineering tool(s) 304 may be one or more applications configured to assess, perform, or analyze certain performance engineering functions (e.g., applications running on the client device, applications running on the virtual server, internal applications or external, third-party applications running on resources external to the virtual server 26 and the client device 20). The performance engineering tool(s) 304 may be configured to implement one or more functions based on one or more inputs 300. For example, an end-user may input a request to access a slow query identification tool of the performance engineering tool(s) 304 to identify any active slow queries (e.g., queries with execution times below a certain threshold, such as an average or expected execution time) running on the client instance 102. As such, the result 302 may be populated (e.g., as a display showing certain slow queries and attributes thereof) and displayed to the end-user on the client device 20.

To implement the one or more performance engineering tool(s) 304, scripts may be stored on the server 26 side, either within or accessible by the virtual server 26 and/or the client instance 102. Specifically, as is described in more detail below, when a request to access a performance tool of the one or more performance engineering tool(s) is received, the client instance 102 identifies the script(s) that defines the performance engineering tool and retrieves the script(s). The client instance 102 uses logs obtained from the application 306 and executes the retrieved script(s). Execution of the script results in data being generated, which is transmitted to the client device 20 as outputs 302. The client device 20 may provide additional requests 300 to access the one or more performance tool(s), which may cause the client instance 102 to run or re-run the retrieved scripts, resulting in additional data, which may be transmitted back to the client device 20 as an additional output 302.

In certain embodiments, the one or more performance tool(s) 304 may perform checks to validate requests via the retrieved script(s). As such, the client instance 102 may run or re-run the retrieved scripts, resulting in additional data, which may be transmitted back to the client device 20 as an additional output 302.

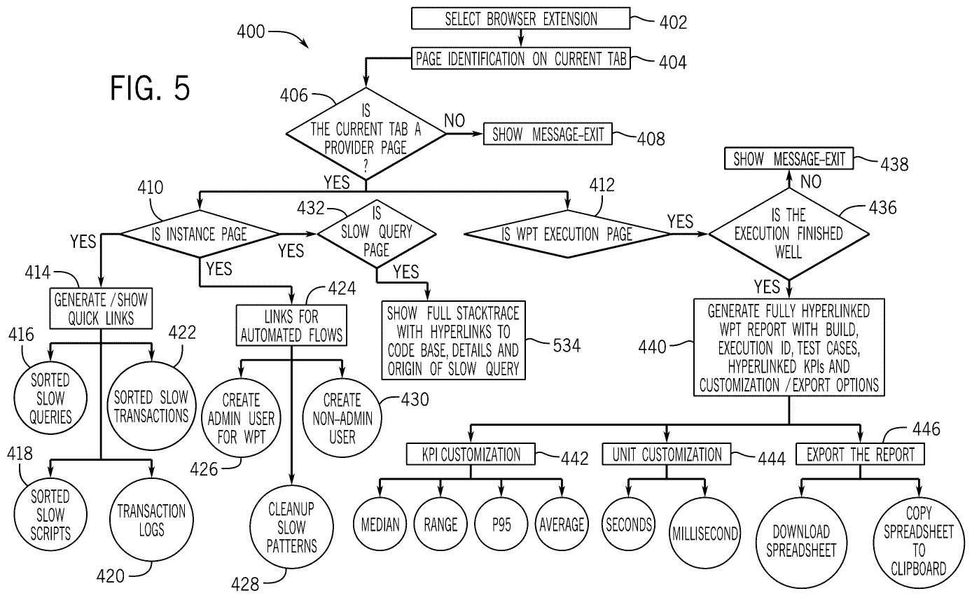

FIG. 5 is flowchart of a process 400 (e.g., performed by the browser extension of the client device) to determine which performance engineering tools to display to an end user. As previously discussed, the browser extension may be configured to suggest certain performance engineering tools based on the type of web page from which the browser extension is accessed/requested. For example, an end user (e.g., a user of the client device 20) may activate the browser extension while browsing a client instance web page. As such, the process 400 may be undertaken by the browser extension to determine that the web page is associated with the client instance and determine the type of links to performance engineering tools to display (e.g., slow queries, slow scripts, transaction logs, slow transactions, etc.).

As such, the process 400 may begin by accessing or requesting the browser extension by clicking an associated icon at block 402. The process 400 may then, at block 404, identify the type of web page from which the request was sent. In certain embodiments, the identification may be completed by identifying an aspect of the web page such as by identifying an aspect of the URL or the source code associated with the web page. Accordingly, the process 400 may include classifying the web page based on the identification executed at block 404. At decision block 406, the web page may be validated. That is, if the web page is determined to not be compatible with the browser extension (i.e., the web page is not an applicable performance engineering web page and/or not a provider page), the process may proceed to display an error message and close the browser extension at block 408. In certain embodiments, the browser extension may only be compatible with web pages that originate from certain client instances (e.g., the client instance 102 of FIG. 4). Alternatively, if the web page is determined to be compatible with the browser extension, the process 400 may proceed to decision blocks 410 and 412.

At decision block 410, the process 400 may display certain performance engineering tools upon determining that the web page is compatible with the browser extension. As such, at block 414, the process 400 may include generating and/or displaying any suitable affordance. An affordance, as used herein, may be any property of a graphical interface through which a user may interact with the graphical interface. Accordingly, the affordances generated and displayed at block 414 (e.g., buttons, links, inputs, checkboxes, dropdown menus, etc.) may facilitate access to one or more performance engineering tools. Accordingly, submitting a request to access the performance engineering tool(s) via the suitable affordance(s) may include identifying and displaying the requested information and/or providing access to the requested information.

As such, the blocks 416-422 represent the performance engineering tool(s) that may be displayed to a user of the browser extension. For example, a button may be generated to facilitate access to a collection of sorted slow queries (i.e., database queries having an execution time above a certain threshold) executed on the web page, as generally represented by block 416. At block 418, an affordance may be generated to link an end user with a collection of sorted slow scripts (i.e., scripts having an execution time above a certain threshold) executed on the web page. At block 420, an end user may access transaction logs (i.e., a log of executed transactions facilitated by the web page) upon clicking an associated affordance. Moreover, at block 422, an end user may access a collection of slow transactions (i.e., transactions having an execution time above a certain threshold) upon clicking an associated affordance. In view of the foregoing, when an affordance is selected by an end user, the end user may be granted access to a display and/or tools that are associated with the particular performance engineering topic.

The process 400 may also include linking to automated tools at block 424 upon determining that the web page is compatible with the browser extension at block 410. An automated tool may be any tool having an associated script for automated processes associated with performance engineering. At block 426, an automated tool button may be generated to provide access to an administrative user creation tool of the web page testing (WPT) environment associated with the web page, where an administrative user may gain full access to any testing associated with the web page. Accordingly, in certain embodiments, the administrative user may be associated with a client instance (e.g., the client instance 102 of FIG. 4). At block 428, an automated tool button may be generated to provide access to a tool facilitating the automated clean up of slow patterns (e.g., queries, slow scripts, transactions). Similar to block 426, at block 430, the process 400 may generate an automated tool button to provide access to a non-administrative WPT user creation tool. Upon creating a non-administrative user, the non-administrative user may gain restricted or otherwise limited access to performance engineering topics associated with the web page (e.g., read-only access).

At block 410, the process 400 may also proceed to determine whether or not the requesting web page is a slow query page at decision block 432. A slow query may be a query executed on/via a database associated with the web page that may have an execution time above a certain threshold number (e.g., an average, median, or expected execution time). As such, identifying such slow queries and allowing access to certain attributes associated with the slow query (e.g., source code) may aid in performance engineering processes. Accordingly, if the web page is identified as a slow query page at block 432, the process 400 may proceed to identify and display a full stack trace having affordances (e.g., buttons, links, inputs, checkboxes, dropdown menus, etc.) facilitating access to certain frames of the stack trace at block 434. As discussed in detail below, a stack trace may represent the logical call order of methods/functions associated with a certain execution (e.g., slow query). The affordances representing each frame of the stack may provide access to an associated code block. In this manner, the user may identify the root cause issue of the slow query by using the stack trace, thereby prompting the user to implement the appropriate corrective action to improve the performance of the slow query (e.g., decrease the execution time).

At decision block 412, the process 400 may determine whether or not the client instance web page is a WPT environment page related to a particular execution. A WPT environment may be any suitable application that analyzes and measures the performance of a web page by executing one or more test cases. For example, the WPT environment may be used to determine execution times for one or more functionalities of the web page via test cases, thereby providing data that may be used to assess the performance of the web page. A WPT execution may include one or more test cases (e.g., scenarios) for data collection. For example, a single execution may include determining the run times for test cases related to opening landing pages and publishers of a web page. Accordingly, at the decision block 412, if the web page is a WPT environment, the process 400 may proceed to decision block 436 to determine if the execution has finished.

If the execution does not fully or sufficiently complete, the process 400 may include displaying an exit message via the browser extension at block 438. Otherwise, the process 400 may proceed to block 440. At block 440, the process 400 may generate and display a report synthesizing the results or data generated by the WPT environment execution via the browser extension. For example, in certain embodiments, the report may be generated to include run times for test cases of the execution while also providing a corresponding hyperlink providing access to code associated with each test case. Accordingly, the browser extension may include any suitable affordances (e.g., buttons, links, inputs, checkboxes, dropdown menus, etc.) capable of allowing a user to customize or interact with the information in the report.

In view of the foregoing, the browser extension may also allow report customization as represented by blocks 442 and 444. For example, at block 442, the browser extension may allow key performance indicator (KPI) customization (e.g., e.g., thresholding, baselining, or calibrating based on medians, ranges, 95^{th} percentiles, averages, and so forth). In this manner, the browser extension may identify and report one or more specified KPIs determined using the WPT execution data based on a selection of relevant KPIs by an end user. That is, a user may select a list of relevant KPIs to include in the report. Accordingly, the KPIs may provide insights into the data generated by the WPT execution. For example, in certain cases, the report generated at block 440 may be used to determine the overall performance of the execution. At block 444, the browser extension may allow unit customization for the report. Accordingly, an end user may choose how KPIs are displayed in the report (e.g., seconds or milliseconds, and so forth).

At block 446, the browser extension may provide an end user with the ability to export the report. In certain embodiments, the browser extension may provide an affordance capable of facilitating a request to copy the populated report to a clipboard. In other embodiments, the browser extension may provide one or more affordances to submit a request to download the report to a file in any suitable file format (e.g., XSLX files, CSV files, XML files, etc.).

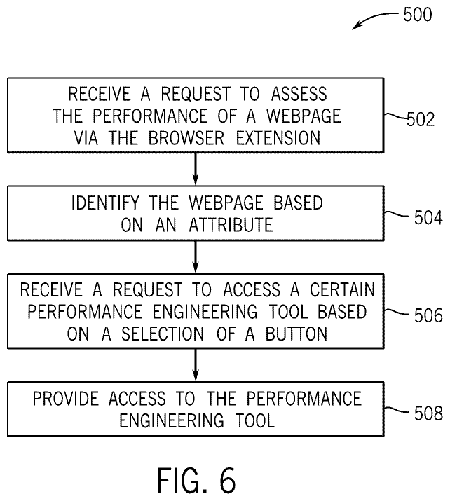

FIG. 6 is a flowchart detailing a process 500 of providing access to a performance engineering tool. As previously mentioned with respect to FIG. 5, the browser extension may be initiated by interacting with a widget or button associated with the browser, while browsing a certain web page. Accordingly, the process 500 may be configured to identify and display performance engineering tools geared towards improving at least one aspect of the performance of the web page.

The process 500 begins at block 502 where a request to assess the performance of a web page may be submitted to a virtual server (e.g., virtual server 26 of FIG. 4) hosting performance engineering tool(s) (e.g., performance engineering tools 304 of FIG. 4) thereon via the browser extension. That is, the browser extension may be accessed by any suitable browser and may subsequently include a request to assess the performance of a web page. In doing so, the web page may be identified based on a certain attribute at block 504. In certain embodiments, the web page may be identified based on a portion of the Universal Resource Locator (URL) and/or the code associated with the web page (e.g., HTML code, cookies, etc.). As such, the attribute may be any attribute associated with the web page providing an indication of the content of the web page. As previously mentioned, the browser extension may be compatible with web pages hosting performance engineering information (e.g., information relating to slow patterns, slow queries, slow scripts, slow transactions, transaction logs, etc.) or a WPT environment for executing one or more test cases for measuring performance.

At block 506, a request to access a certain performance engineering tool based on the selection of an affordance (e.g., button, hyperlink, drop-down menu, radio button, etc.) may be received. That is, the browser extension may display affordances to allow a user to select one of multiple performance engineering tools, where the selection of the affordance provides the virtual server with a request to access the certain performance engineering tool.

At block 508, the process 500 may provide access to the certain performance engineering tools, in response to the request of block 506 being granted or validated. In certain embodiments, the end user of the browser extension may access the performance engineering tool via a pop-up window and/or browser tab provided by the browser extension. In other embodiments, the performance engineering tool may be embedded into the browser extension window. In this manner, the browser extension may provide the benefit of allowing certain executions related to performance engineering (e.g., sorted slow queries, sorted slow scripts, sorted slow transactions) to be accessed from a single location, as opposed to requiring a user to manually identify poor-performing executions. As a result of the ease of access to such performance engineering tools, the efficiency of performance engineering processes may be increased.

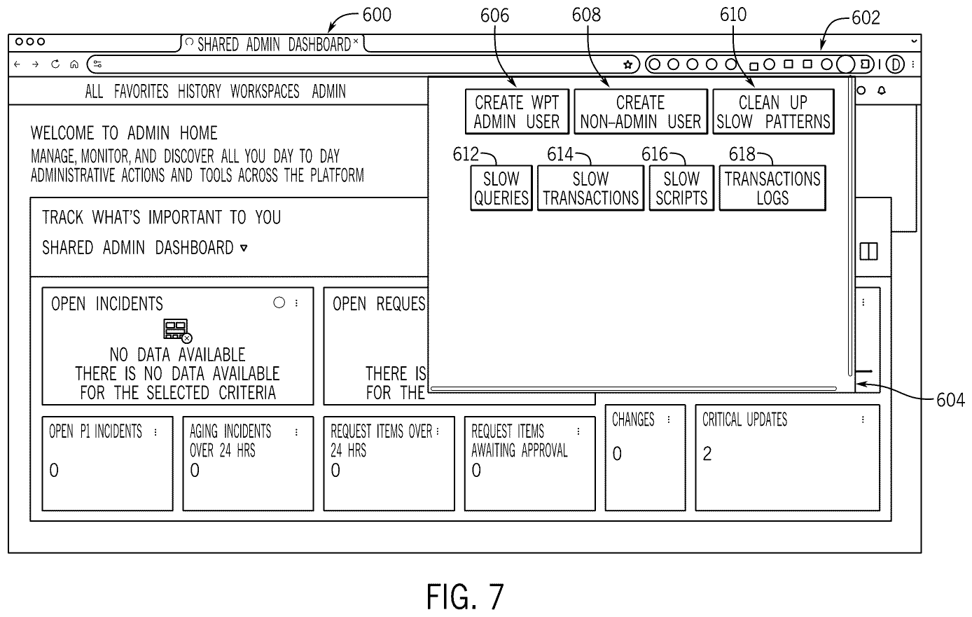

FIG. 7 is a screen shot of an embodiment of the browser extension, where the browser extension may present buttons to access one or more performance engineering tools. As previously discussed, the browser extension may be configured to display a selection of performance engineering tools based on an identifier of the web page from which the browser extension is accessed (e.g., a URL, HTML code, etc.). Accordingly, the illustrated embodiment displays an example in which the browser extension may identify that the web page is associated with performance engineering processes, thereby providing the corresponding performance engineering tools via buttons facilitating access to performance engineering tools.

As previously mentioned, the browser extension may be initiated or otherwise accessed from any suitable browser 600 by selecting a corresponding widget/button 602 of the browser. Accordingly, upon selecting the widget/button 602, the browser extension may send a request to a virtual server (e.g., virtual server 26 of FIG. 4) hosting performance engineering tool(s) (e.g., performance engineering tools 304 of FIG. 4) thereon to assess the performance of a web page. Accordingly, within the request, an identifier of the web page may be included to identify the type of web page the user is browsing. In the illustrated embodiment, the user is browsing an administrative dashboard associated with performance engineering and/or debugging processes. Accordingly, the administrative dashboard may be associated with a client instance (e.g., the client instance 102 of FIG. 4), and may include data related to performance engineering processes for the client instance (e.g., data related to slow queries, slow transactions, slow patterns, etc.) As such, the browser extension may be configured to make the identification based on an attribute of the web page indicative of the content thereon (e.g., a portion of the URL, etc.). Once the type of web page is identified, the browser extension may prompt a browser extension window 604 to display and may populate the browser extension window 604 with affordances (e.g., buttons 606-618) facilitating access to performance engineering tools. Upon selecting any of the buttons 606-618, the browser extension may prompt the performance engineering tool to be opened via a separate tab of the browser 600, embedded in the browser window 604, and/or a new window of the browser 600.

The WPT admin user creation tool button 606 may provide the option of creating an admin user for the WPT environment for the web page. Upon selecting the WPT admin user creation tool button 606 (e.g., affordance), the browser extension may process a request to access the WPT admin user creation tool and provide access to the tool to the user. Upon gaining access to the WPT admin user creation tool, the user may provide the browser extension with the appropriate information (e.g., name, user ID, credentials, login, etc.) to create a new admin user for the WPT environment for the web page. As such, the browser may process the entered information and create the new admin user, thereby automating the process of creating a new administrative user. Similarly, the non-admin user tool button 608 may provide access to a tool allowing the creation of a non-admin user for the WPT environment. As previously mentioned, a non-admin user may gain less access to the WPT environment as compared to the admin user (e.g., a read-only or otherwise restricted or limited access).

The slow pattern tool button 610 may provide access to a list of sorted slow patterns monitored by the web page upon its selection. As previously mentioned, in the illustrated embodiment, the web page is an administrative dashboard containing information related to performance engineering. As such, certain executions identified by the web page may be monitored for performance. Turning to the slow pattern tool button 610, a slow pattern may be any repeated performances of the client instance (e.g., transactions, scripts, queries, events, mutexes, cache, etc.) that consistently display poor behavior (e.g., long runtimes, excessive iterations, unnecessary filtering/processing, etc.) The slow pattern tool button 610 may grant a user access to a tool used to identify the slow patterns and reconcile them by any suitable debugging process (e.g., by providing access to certain code blocks). In providing the user access to the tool, the browser extension may be configured to identify and present a sorted list of the slow patterns included on the web page.

The slow queries tool button 612 may provide access to a tool allowing the user to identify certain slow queries exhibited on the client instance, upon its selection. Certain client instances may use one or more databases to store and retrieve information via queries. As such, selecting the slow queries tool button 612 may urge the browser extension to identify any queries executed on by the client instance exhibiting poor performance (e.g., queries having a runtime above a threshold value). In certain embodiments, a list of sorted slow queries may be presented to the user including the query itself and the runtime execution. Additionally, in certain embodiments, the slow queries tool may include a bookmarking functionality to allow certain portions of code to be easily referred to during debugging processes. Moreover, the list of sorted slow queries may include hyperlinks to the queries and any associated code, thereby allowing a user with quick access to the code for debugging or other improvement processes.

The slow transactions tool button 614 may provide access to a tool to identify and debug certain slow transactions exhibited on the client instance, upon its selection. As referred to herein, a transaction may be any operation applied to the client instance that may access or alter the records stored thereon (e.g., create, read, upload, delete, etc.). Moreover, a slow transaction may be any transaction having an associated execution time over a threshold value. Accordingly, the slow transactions tool button 614 may be used to identify any slow transactions (e.g., transactions exhibiting runtimes over a certain threshold), sort such slow transactions into a list, and provide access to relevant code and information. As such, a user may use such information to apply debugging or other corrective measures to improve the performance of under-performing transactions.

The slow scripts tool button 616 may provide access to a tool allowing the user to identify and debug certain slow scripts upon its selection. As used herein, a script may be used to automate tasks and/or handle custom functionality and logic. Slow scripts may be any scripts exhibiting poor behavior (e.g., long runtimes, excessive iterations, etc.) executed on the client instance. In certain embodiments, a script may be determined to be a slow script if its execution time is over a threshold script time. Accordingly, selecting the slow scripts tool button 616 may provide access to a list of slow scripts executed on the instance, relevant information (e.g., labels, execution times, execution counts, last sighting, etc.), and access to the source code of the script via suitable affordances (e.g., hyperlinks, buttons, etc.). In certain embodiments, the browser extension may be configured to sort the list of slow scripts based on relevant information determined (e.g., execution times). As such, a user may identify poorly performing slow scripts and may easily access associated code to implement corrective actions (e.g., debugging, improvement, etc.).

The transaction log tool button 618 may provide access to a log of transactions executed on the client instance upon its selection. As mentioned previously, a transaction may be any operation applied to the web page. Accordingly, selecting the transaction log tool button 618 may provide access to a list of the transactions and relevant information (e.g., state, type, execution times, source, etc.) thereby providing a user with information needed to determine the performance of transactions submitted on the web page. In certain embodiments, the transaction logs may be sorted based on relevant information (e.g., sorted by latest transaction, alphabetical label order, highest execution times, etc.)

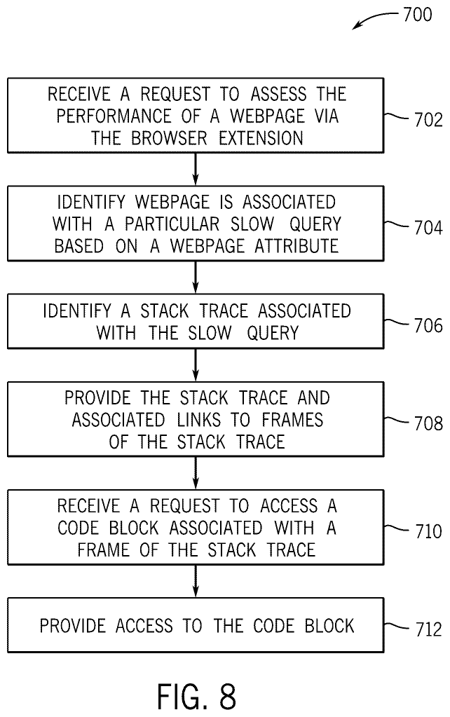

FIG. 8 illustrates a process 700 that may be used to provide access to a stack trace associated with a slow query via the browser extension. As discussed above, a user may be interested in identifying slow queries for debugging purposes. In certain cases, queries may be associated with a stack. A stack may refer to the logical call order of the methods/functions of an execution, where “last in, first out” describes the call order. For example, the first method/function called may be the last method/function pushed to the stack, and the last method/function called may be the first method/function pushed to the stack. Accordingly, the user may utilize a stack trace to evaluate the performance of a query with respect to the logical call order. In certain cases, the user may efficiently debug queries by observing the performance output of the stack trace.

Accordingly, the process 700 begins at block 702 where a virtual server (e.g., virtual server 26 of FIG. 4) hosting performance engineering tool(s) (e.g., performance engineering tools 304 of FIG. 4) thereon may receive a request submitted by the browser extension to assess the performance of a web page. As such, at block 704, the performance engineering tool(s) may proceed to identify that the web page is associated with a particular slow query based on an attribute (e.g., URL, source code) of the web page associated with the request. For example, in certain cases, a request to assess the performance of the web page (e.g., open the browser extension) may be submitted while browsing a web page hosting thereon information regarding the slow query (e.g., query example, example stack trace, example URL, etc.).

At block 706 the performance engineering tool(s) may proceed to identify a stack trace associated with the slow query. As previously mentioned, the stack trace may be the call order for scripts/code associated with the slow query. Accordingly, the performance engineering tool(s) may be configured to identify the stack trace via the information contained on the web page. As such, at block 708, the browser extension may proceed to provide the stack trace (e.g., by the graphical representation) and associated links to frames (e.g., code block) of the stack trace. Upon identifying the stack trace, the browser extension may be configured to display the stack trace and/or representations of the stack trace by a suitable graphical representation. For example, the browser extension may be configured to display the stack trace as a flowchart describing the logical call order of stack frames. Accordingly, a user may be provided with information regarding the stack and individual frames and may access the code associated with each frame. In this manner, the user does not need to manually identify relevant stack frames from long, convoluted call logs. As such, the efficiency of performance engineering processes may be improved.

At block 710, the performance engineering tool(s) may proceed to receive a request to access a code block associated with a frame of the stack trace. As mentioned above, each frame may be displayed to the user having a hyperlink to the associated code block. As such, the user of the client device may request to access the code by selecting the link. Accordingly, upon approving and/or validating the request, the browser extension may provide access to the code block at block 712. Access to the code block may be displayed to the user via the browser extension window or in a separate tab, window, or application to allow the user to read or make edits to the code block.

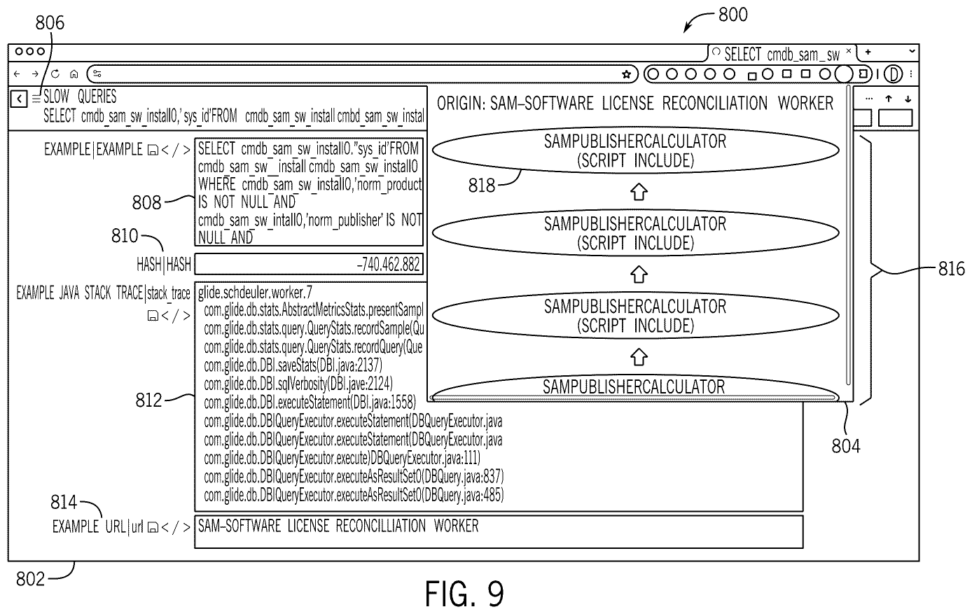

FIG. 9 is a screenshot illustrating the stack trace functionality of the browser extension, as discussed above with respect to FIG. 8. In accordance with the above discussion, it should be understood that the stack trace functionality may be applied to web pages associated with slow queries. Accordingly, the browser 800 displays an embodiment of the browser extension as used for performance engineering debugging for slow queries. As mentioned above, the browser extension may be accessed by any suitable browser 800 by selecting the requisite widget/button while browsing a web page 802.

Upon initiating the browser extension, a browser extension window 804 may display. The browser extension window 804 may be populated with information based on the content of the web page, as determined by the browser extension based on the identifier of the web page (e.g., URL, source code, etc.). As displayed in the illustrated embodiment, the web page 802 is associated with slow queries. For example, the information displayed within the browser extension window 804 pertains to the characteristics of slow queries 806. In the illustrated embodiment, the characteristics include example query 808, the query hash 810, example stack trace 812, and example URL 814. Accordingly, the illustrated embodiment displays an example of a web page associated with slow queries that may be used to identify and debug such slow queries.

The browser extension may populate a stack trace 816 associated with the slow queries. As shown in the illustrated embodiment, the web page may already contain an example stack trace. As illustrated in the example, the example stack trace 812 provided may be difficult to interpret and draw conclusions from, based on the text alone. As such, the browser extension may synthesize the information such that the stack trace is able to provide organized, usable information in a graphical format.

Additionally, the stack trace 816 may provide access to frames of the stack trace, thereby allowing the user to be automatically directed to a certain code block associated with a stack frame. For example, in the illustrated embodiment, the user may select a stack frame 818 by clicking the associated hyperlink. Upon clicking the hyperlink, the browser extension may process the request and provide access to the code block associated with the stack frame 818. In certain embodiments, the code block may be displayed in a separate tab/window that automatically opens upon selecting the link. In other embodiments, the browser extension may be configured to provide access to the code block within the browser window 804. In certain cases, a user may identify that the code block of a certain stack frame is causing an error. For example, a user may execute a query having a syntax error associated with a code block of a stack frame in the middle of the stack. As such, the user may request access to the code block to identify the root cause of the error. Upon receiving access to the code block, a user may be able to edit the code block to improve the performance associated with the code block and/or debug the code block.

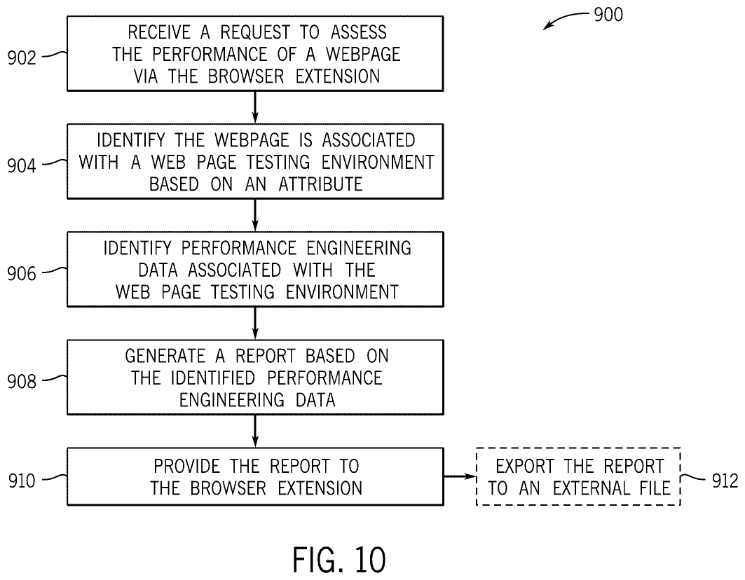

FIG. 10 illustrates a process 900 for generating a report of performance metrics and/or KPIs for test cases executed in a WPT environment via the browser extension. As previously mentioned, the browser extension may be configured to provide the option to generate and/or export a report detailing the results of certain test cases conducted in a WPT environment, to make performance engineering decisions, and so forth. For example, a user may design test cases to gain data insights into functionalities of a web page such as load times for certain elements. Accordingly, the results of such test cases may provide a baseline for improvement of certain functionalities of the web page, thereby driving performance engineering processes. The report generation functionality may synthesize information collected via WPT executions and display it to a user in an organized format, after which the user may choose to export the report to an external source.

The process 900 begins at block 902 where the browser extension may send a request to a virtual server (e.g., virtual server 26 of FIG. 4) hosting performance engineering tool(s) (e.g., performance engineering tools 304 of FIG. 4) thereon to assess the performance of a web page. As previously mentioned, the request may be initiated upon opening the browser extension by selection of a widget/button. At block 904, the performance engineering tool(s) may identify that the web page is associated with a WPT environment based on an attribute (e.g., URL, source code) of the web page included with the request. The WPT environment may allow a user to create and run test cases on a web page to identify and log performance issues. As such, at block 906, the performance engineering tool(s) may identify the performance engineering data associated with the WPT environment execution. That is, the performance engineering data may include the results of the test cases. As such, the performance engineering data may include test case labels, run times, iteration counts, events, etc.

At block 908 the performance engineering tool(s) may generate a report based on the identified performance engineering data. That is, the performance engineering data determined at block 906 may be synthesized and represented in graphical/textual format. For example, the report may include a list of the sorted test cases and runtime executions associated with each case. In certain embodiments, the report may include statistical analysis performed by the performance engineering tool(s). For example, the execution times may be determined over multiple iterations of tests and sorted into KPIs such as medians, ranges, and 95^{th} percentiles. As such, at block 910, the report may be provided to the browser extension. In certain embodiments, the report may be displayed within the window of the browser extension. At block 912, the process 900 may present an option to export the report to an external file and download it locally. Accordingly, the report may be downloaded in any suitable format for viewing the data contained therein (e.g., XSLX files, CSV files, XML files, etc.). In this manner, the ability to automatically generate and export a report for a certain execution may increase the efficiency of performance engineering processes. That is, by automatically determining KPIs associated with the execution and arranging such data into a report, the user may circumvent the process of doing so manually, thus saving time and resources.

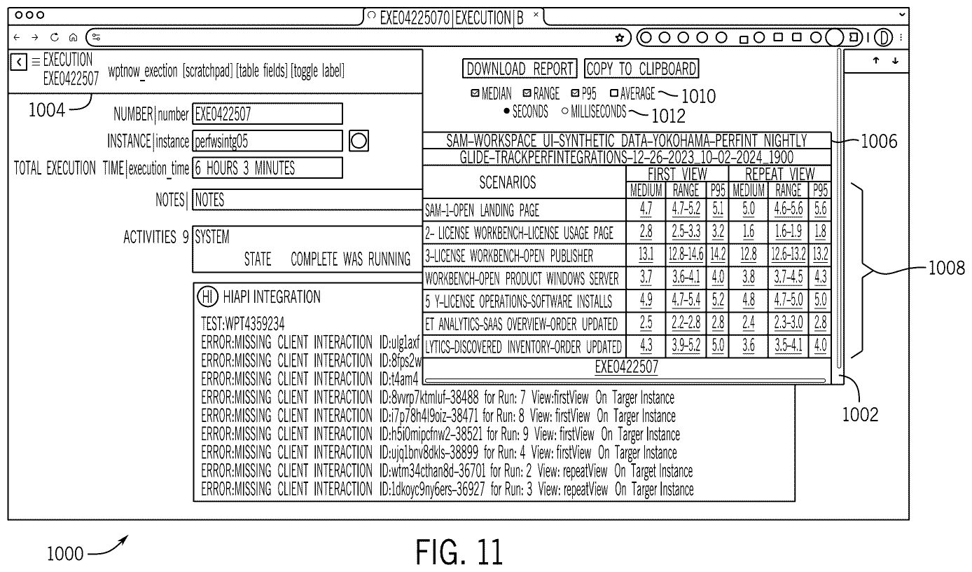

FIG. 11 illustrates a screenshot of the report generation functionality for web pages that have been identified as WPT environments. As mentioned above with respect to FIG. 10, a WPT environment may include one or more test cases used to establish metrics related to performance engineering. As such, the browser extension may be configured to identify information related to such test cases (e.g., execution times) appearing on a WPT web page and create a report corresponding to the information. Moreover, the browser extension may be configured to determine one or more KPIs associated with the test cases based on the information hosted thereon the WPT web page and include the KPIs within the report.

As previously discussed, the browser extension may be accessed via a widget or button of the browser 1000, thereby prompting a browser window 1002 to open. Upon opening the browser window 1002, the browser may be configured to determine what type of web page is being accessed. As displayed in the illustrated embodiment, the page is a WPT web page as evidenced by the label 1004 “wptnow_execution”. As such, in accordance with the method described above with respect to FIG. 10, the browser extension may be configured to identify an aspect of the web page (e.g., URL, source code, etc.), and use the information hosted on the web page to generate the report 1006 within the browser window 1002.

The report 1006 may contain test cases 1008 that are included within the WPT execution. The test cases 1008 may include KPIs associated with each test case, as recorded within the WPT execution. For example, in the report 1006, each test case includes the KPIs median, range, and 95^{th} percentile data. The browser extension may allow selection of which KPIs (e.g., median, range, 95^{th} percentile, average) are included within the report by selecting the checkboxes 1010. Moreover, the browser extension may allow the ability to adjust the units displayed within the report by selecting a radio button 1012. In the illustrated embodiment, the user has elected to display the test cases in seconds. Although one example of metrics the report 1006 may be generated to track is included in the description above, it should be understood that the browser extension may generate other metrics associated with test cases for performance engineering purposes (e.g., execution counts, etc.) and visual representations of such metrics (e.g., graphs, charts, etc.). For example, in certain embodiments, the report may include a visual representation of the 90^{th} percentile test case completions for the execution.

The browser extension may also provide the ability to export the report to an external source. In the illustrated embodiment, the buttons 1014 may be selected to download the report and/or copy the report to clipboard. As mentioned above, the browser extension may be configured to export the report for downloading in any suitable format (e.g., XSLX files, CSV files, XML files, etc.). In certain embodiments, the browser extension may be configured to submit a request to export the report via email.

In certain embodiments, the browser extension may provide the ability to select information to be included in the report. For example, the browser extension may filter out certain iterations of the test case executions (e.g., first views, repeat views, etc.) while generating the report. Moreover, in certain embodiments, the browser extension may be configured to generate temporary reports for executions that are in progress.

The presently disclosed techniques are directed to systems and methods to monitor and access performance metrics and workflows of a web page via a browser extension. In embodiments described herein, the browser extension may be used to identify and access workflows to optimize an associated performance of the web page based on an attribute of the web page. For example, the browser extension may identify that the web page is related to debugging one or more functions of the web page (e.g., slow queries, slow transactions, slow scripts, etc.) and provide access to the one or more relevant workflows via any suitable user interactivity options (e.g., hyperlinks, buttons, etc.). As a further example, the browser extension may identify and display stack traces of certain web page executions thereby providing access to one or more stack frames of the executions for debugging. In certain embodiments, the browser extension may populate a report based on the type of web page from which the browser extension is requested. For example, a web page may be identified as a web page testing environment for designing optimization processes by way of test cases. Accordingly, the browser extension may populate a report based on the key performance indicators (KPIs) of such test cases in the testing environment and provide one or more options to export the report to an external source (e.g., XSLX files, CSV files, XML files, etc.). Techniques disclosed herein are directed to streamlining performance engineering processes by providing easy access to various tools and metrics associated with improving web page performance. As such, performance engineering processes may operate with greater efficiency, consuming fewer resources (e.g., computing resources, human resources, etc.), resulting in faster, better performing web pages.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving, via a browser extension, a request to assess performance of a web page;
identifying an attribute of the web page;
presenting, via the browser extension, based on the attribute, one or more affordances, wherein each affordance of the one or more affordances is associated with a performance characteristic of the web page;
receiving a request to access data based on a selection of an affordance of the one or more affordances; and
providing, via the browser extension, a representation of the data for display.

2. The method of claim 1, further comprising:
determining that the attribute of the web page is that the web page corresponds to a testing environment;
generating a report based on the data and the testing environment.

3. The method of claim 2, comprising exporting the report to one or more external sources.

4. The method of claim 2, wherein generating the report comprises selecting one or more key performance indicators (KPIs) of the one or more performance characteristics to include in the report.

5. The method of claim 2, wherein generating the report comprises selecting a unit of measurement to apply to the one or more performance characteristics.

6. The method of claim 1, comprising:
determining that the attribute of the web page corresponds to a workflow;
generating a stack trace associated with the workflow based on an additional attribute of the web page;
providing, via the browser extension, the stack trace for display.

7. The method of claim 6, wherein the stack trace comprises one or more stack frames, and wherein each stack frame of the stack trace comprises a hyperlink corresponding to a portion of code associated with the workflow.

8. The method of claim 1, wherein the affordance comprises one or more performance tools configured to improve the respective performance characteristics of the one or more performance characteristics.

9. The method of claim 1, wherein the one or more performance characteristics correspond to one or more actions executed by the web page comprising:
one or more queries that take longer than a threshold query time to execute;
one or more transactions that take longer than a threshold transaction time to execute;
one or more scripts that take longer than a threshold script time to execute; or
a combination thereof.

10. A system, comprising:
processing circuitry; and
a memory, accessible by the processing circuitry, and storing instructions that, when executed by the processing circuitry cause the processing circuitry to perform operations comprising:
receiving, via a browser extension, a request to assess performance of a web page;
identifying an attribute of the web page;
presenting, via the browser extension, based on the attribute, one or more affordances, wherein each affordance of the one or more affordances is associated with a performance characteristic of the web page;
receiving a request to access data based on a selection of an affordance of the one or more affordances; and
providing, via the browser extension, a representation of the data for display.

11. The system of claim 10, wherein the operations comprise:
determining that the attribute of the web page is that the web page corresponds to a testing environment;
generating a report based on the data and the testing environment.

12. The system of claim 11, wherein the operations further comprise exporting the report to one or more external sources.

13. The system of claim 11, wherein generating the report comprises selecting one or more key performance indicators (KPIs) of the one or more performance characteristics to include in the report.

14. The system of claim 11, wherein generating the report comprises selecting a unit of measurement to apply to the one or more performance characteristics.

15. The system of claim 10, wherein the operations comprise:
determining that the attribute of the web page corresponds to a workflow;
generating a stack trace associated with the workflow based on an additional attribute of the web page;
providing, via the browser extension, the stack trace for display.

16. A non-transitory, computer readable medium comprising instructions that, when executed by processing circuitry, cause the processing circuitry to perform operations comprising:
receiving, via a browser extension, a request to assess performance of a web page;
identifying an attribute of the web page;
presenting, via the browser extension, based on the attribute, one or more affordances, wherein each affordance of the one or more affordances is associated with a performance characteristic of the web page;
receiving a request to access data based on a selection of an affordance of the one or more affordances; and
providing, via the browser extension, a representation of the data for display.

17. The non-transitory computer readable medium of claim 16, wherein the operations comprise:
determining that the attribute of the web page is that the web page corresponds to a testing environment;
generating a report based on the data and the testing environment.

18. The non-transitory computer readable medium of claim 16, wherein the operations comprise:
determining that the attribute of the web page corresponds to a workflow;
generating a stack trace associated with the workflow based on an additional attribute of the web page;
providing, via the browser extension, the stack trace for display.

19. The non-transitory computer readable medium of claim 18, wherein the stack trace comprises one or more stack frames, and wherein each stack frame of the stack trace comprises a hyperlink corresponding to a portion of code associated with the workflow.

20. The non-transitory computer readable medium of claim 16, wherein the operations comprise:
one or more queries that take longer than a threshold query time to execute;
one or more transactions that take longer than a threshold transaction time to execute;
one or more scripts that take longer than a threshold script time to execute; or
a combination thereof.
